(19) United States
(12) Patent Application Publication
(10) Pub. No.: US 2006/0272145 A1
(43) Pub. Date: Dec. 7, 2006

(54) Method of producing superconducting wire and articles produced thereby

(75) Inventors: John B. Hendricks, Huntsville, AL (US); William K. McDonald, Madison, AL (US)

Correspondence Address: LANIER FORD SHAVER & PAYNE, P O BOX 2087, HUNTSVILLE, AL, 35804, US

(73) Assignee: Alabama Cryogenic Engineering, Inc., Huntsville, AL (US)

(21) Appl. No.: 11/373,717

(22) Filed: Mar. 10, 2006

Related U.S. Application Data
(60) Provisional application No. 60/661,109, filed on Mar. 11, 2005.

(51) Int. Cl. H01B 12/00

(52) U.S. Cl. 29/599; 174/125.1

(57) ABSTRACT

A method of manufacturing a multi-filamentary superconducting wire comprises making a laminate of an expanded base metal lamina and a reactant metal lamina, tightly wrapping the laminate around a metal core and then hydrostatically extruding it. The expanded base metal may be either niobium or vanadium, the reactant metal may be one of tin, aluminum, germanium, gallium, and titanium. In the making of Nb₃Sn superconducting wire, the reactant metal may be an alloy of tin, for example, Babbitt metal. A third lamina may be added to the laminate to prevent radial movement of the reactant metal during processing.

### CROSS-REFERENCE TO RELATED APPLICATIONS

This application claims the benefit of U.S. provisional application Ser. No. 60/661,109, filed Mar. 11, 2005, and incorporated by reference herein.

### GOVERNMENT RIGHTS

This invention was made with Federal Government funding under SBIR Grant No. DE-FG02-01ER86122. Therefore, the Federal Government has certain rights in this invention.

### BACKGROUND

### Description of the Related Art

Type II superconductors are used in high-energy physics applications because of their ability to conduct current with almost zero resistance in the superconducting state and in the presence of a high magnetic field. Such applications include particle accelerators and colliders, nuclear magnetic resonance (NMR) spectroscopy, anti-gravity, among others. The effectiveness of such superconductors is measured using three parameters: critical temperature, θ (in Kelvin) to which the superconductor must be cooled to enter a superconductive state; current density, J_{c} (in A/mm²) through the superconductor cross-section at or below θ, and, critical field, B_{c} (in T) generated by the superconductor above which superconductivity ceases. Intuitively, it is desired for superconductors to demonstrate the highest values possible for these parameters.

The best-known Type II superconductors include a variety of alloys comprised of elements such as Niobium, titanium, gallium, vanadium, tantalum, aluminum, germanium, lead and tin. Heretofore, processes to manufacture Type II superconductors have been developed. Further, Type II superconductors have been developed in experimental or laboratory conditions that demonstrate high current densities and high critical fields. However, no economically feasible process exists to manufacture superconductors in industrial quantities with superior performance characteristics. Typically, superconducting wires are composed of a superconducting material encased in copper, or some other conventional conductor, and are made in relatively short lengths (meters) and then, depending upon the application, spliced together. The outcome is dubious structural integrity. Also, currently known processes tend to suffer from shortcomings that limit the efficiency of the superconductor. For example, it is known that in producing the superconductor Nb₃Sn, increased J_{c} results from more uniform distribution of the tin through the niobium in a copper or bronze matrix prior to heat treatment. This is because gradients in tin distribution result in reductions of the pinning force required to prevent “flux jumps,” or migrations of local flux fields, that tend to reduce J_{c}. It is further desirable for superconducting wire to be as thin as possible while still being able to carry a high current density. The superconductor dimension, in terms of effective filament diameter, measures the diameter of the non-copper, or superconducting material in a rod or wire.

There are in essence four processes used in the current art to fabricate superconducting wire, each suffering from one or more shortcomings. The first, and probably most used, is referred to as the “Bronze Process” where tin is alloyed with copper to form bronze which is then co-reduced with niobium and then reacted through heating. The drawback of this solution is that the bronze alloy must be ductile to be reduced with the niobium. The ductility limit of bronze occurs where the alloy includes about 18% tin by atomic weight. This limits the amount of tin available for the Nb₃Sn, and therefore limits the non-copper current density, J_{c}. While the effective current diameter of superconducting wire manufactured by this process has been reduced to 10 microns, the best current density thus far achieved is less than roughly 1000 A/mm².

The “powder process” uses a powdered NbSn alloy (Nb₅Sn₆) to mix with niobium powder in a niobium tube. The tube is reduced and restacked with other reduced tubes and reduced again to form a multi-filamentary wire. The cost and time required to perform the process limit its effectiveness to produce industrial quantities of superconducting wire. For example, the cost of wire produced by this method is roughly ten times that of a wire produced by other previously known processes.

A third process is known as the “external tin” process where tin is applied around the surface of a niobium-copper composite reduced to its final size. The tin is diffused into the wire's cross-section and alloyed with the copper at a relatively low temperature and the then superconductor is created during heat treatment at a higher temperature. However, this process so far has failed to yield a usable superconducting wire.

Finally, the “internal tin” process uses a tin rod as the core of a niobium and copper cylindrical structure and reduced using conventional drawing. Diffusion of the tin occurs in heat treating after the final size is achieved. The resultant wire fails to achieve current densities above 3000 A/mm² because not all of the tin diffuses and the remaining tin core takes up about 30% of the cross-sectional area that is “lost,” or unusable for superconducting. Further, the resulting tin concentrations differ between the inner and outer parts of the niobium-copper structure.

Another problem of the current art is the methods used to reduce the material to wire diameters. Cold drawing is where the material is pulled through a die. One shortcoming of this technique is its limited reduction capacity. The limit of the area reduction ratio is a function of the tensile strength of the drawn material. It is known that the force required to pull a rod through a die is given by:
F_{PULL}=A₂σ_{FLOW} ln(A₁/A₂) where
σ_{FLOW} is the flow stress of the material, and A₁, and A₂ are the starting and ending cross-sectional areas, respectively.

If the value of F_{PULL} approaches the rod tensile strength, a break occurs. Since flow stress approximates tensile strength, the maximum area reduction ratio per pass that can result is e=2.718. This means that in order to achieve typical wire diameters, either the starting diameters must be smaller, or there must be an increased series of reductions, or both. Any of these options are impractical to produce the quantities of wire necessary for economic feasibility at the improved performance states. Further, since the area reduction is limited, only a small fraction of the drawn rod is deformed. The inner portion does not experience the same deformation as the outer material. Internal flow counter to the stress on the outer portion results creating internal longitudinal stress patterns which can result in failures in composites if the elements are not well-bonded. Another drawback of cold drawing is that the draw benches on which the drawn rod is pulled after it emerges from the die must be long enough to accommodate the rod. Coiling the layered rod at some point may result in internal stress levels as well.

A somewhat related method is direct extrusion where material is placed into an extrusion vessel and is forced through a die by a ram in direct contact with the extrusion vessel. A problem with direct extrusion in making superconducting wires, such as Nb₃Sn, is that metals like tin have a relatively low melting point. Direct extrusion with large area reductions heats the extruded material in two ways, adiabatically, and through friction generated the contact of the extrusion vessel on the inner wall of the extrusion chamber. The heat melts some of the constituent elements at a lower temperature than other elements, resulting in non-uniform distribution and premature reaction of the elements. Further, direct extrusion places both longitudinal stresses on the extruded material that tends to cause the material to be forced radially. Because of the relatively higher ductility of some elements, the extruded material reacts to flow stresses by shifting, again resulting in non-uniform distribution. To avoid this, it is desirable to use lower reduction ratios, but this limits the advantage of direct extrusion. Also, the direct extrusion press can only handle short lengths given the diameters needed to achieve desired wire dimensions. Any greater, and the material would fail. So the process is limited to the initial reduction. Thereafter, the material is typically cold drawn. Moreover, to achieve smaller effective filament diameters, drawn rods must be re-stacked and re-drawn. But because of the limitations of cold drawing and direct extrusion, effective filament diameter cannot be reduced below 50 microns.

U.S. Pat. No. 4,262,412, issued Apr. 21, 1981 to McDonald, a co-inventor of the present invention, describes a method for making Type II superconducting wire formed through the reduction of a laminate comprised of two metals where one of the laminae is a sheet of expanded metal that is the base metal of an alloy, for example, Nb, and the other laminae is a solid sheet of a reactant metal such as aluminum, copper, tantalum or in the case of Nb₃Sn, bronze, or the so-called “Bronze Process.” The laminate is wound around a core, usually of copper, and then reduced through direct extrusion. This method has manifested two shortcomings. First, the use of bronze to supply the tin needed for Nb₃Sn means that the tin content is limited, as noted above, reducing the effective area of conductivity. Second, diffusion of the tin from the bronze is non-uniform.

A progeny patent, U.S. Pat. No. 4,414,428, issued Nov. 8, 1983, again to McDonald, describes the use of an expanded metal layer in the making of a jelly roll to manufacture multi-filamentary wire where the expanded may act as either a conducting layer, a strengthening layer or a diffusion barrier. However, these uses still fail to address the problem of uniform distribution of reactant, particularly of tin, during processing. This reference expounds the use of bronze in making Nb₃Sn to diffuse the tin into the Nb layer over the use of a tin layer.

Last, hydrostatic extrusion has been known in the art, and has been used in the making of superconducting wire. However, heretofore, it has only been used for an initial reduction. Thereafter, the wire is cold drawn. The reason is that it has not been used for further reduction is that pressure chambers had not been thought to accommodate the size of the extruded material needed to achieve usable lengths of wire.

Thus, a process is required that produces a superconducting wire that contains a uniform distribution of reactant metal.

### SUMMARY

Herein described is a manufacturing process that has been demonstrated to reliably provide a superconducting wire with substantially uniform distribution of reactant metals, and thus of superconducting material. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein.

In one embodiment, the disclosed method of manufacturing a multi-filamentary superconducting wire comprises making a laminate of an expanded base metal lamina and a reactant metal lamina, tightly wrapping the laminate around a metal core and then re-iteratively, hydrostatically extruding it.

In a further embodiment, the expanded base metal is either niobium or vanadium, and the reactant metal may be one of tin, aluminum, germanium, gallium, and titanium. In a further embodiment, particularly in the making of Nb₃Sn superconducting wire, the reactant metal may be an alloy of tin, for example Babbitt metal.

In another embodiment, the laminate comprises a third layer of a stabilizing material that prevents radial movement of the reactant metal during processing. The term radial movement is understood to mean movement normal to the axis of the core metal.

An object of the present invention is to manufacture superconducting wire in a feasible manner, that still achieves a current density of greater than 3000 A/mm² with an effective filament diameter of about 20 microns or less.

These and other embodiments of the present invention will also become readily apparent to those skilled in the art from the following detailed description of the embodiments having reference to the attached figures, the invention not being limited to any particular embodiment(s) disclosed.

### BRIEF DESCRIPTION OF THE DRAWINGS

The present invention is described with reference to the accompanying drawings. In the drawings, like reference numbers indicate identical or functionally similar elements. Additionally, the left-most digit(s) of a reference number identifies the drawing in which the reference number first appears.

FIG. 1 is a flowchart illustrating the method according to an embodiment of the present invention;

FIGS. 2A and 2B depict an extrusion vessel according to an embodiment of the present invention; and

FIG. 3 is an illustrative cross section of an exemplary superconducting wire according to an embodiment of the present invention.

### DETAILED DESCRIPTION

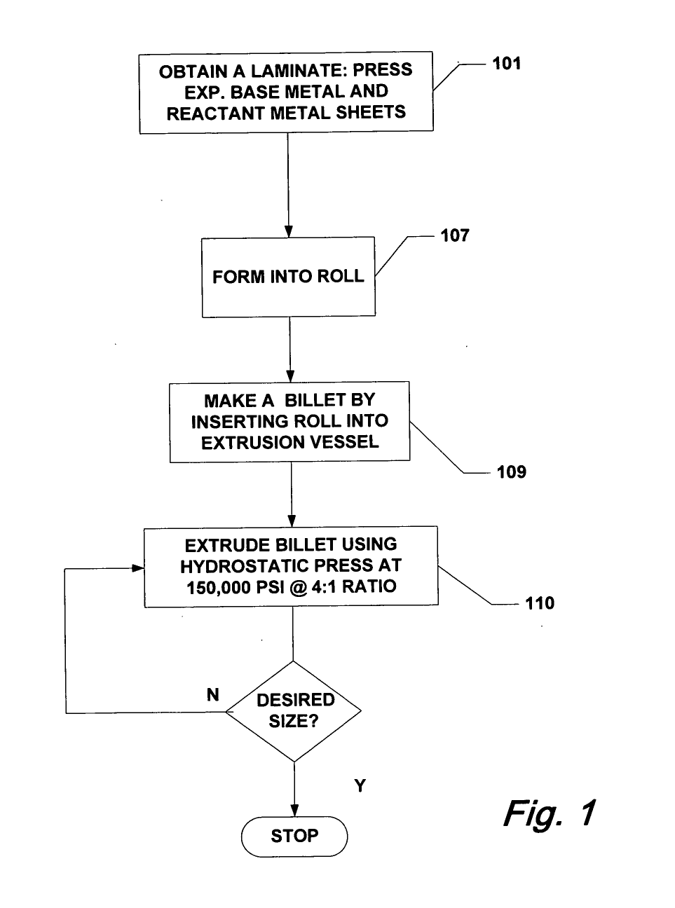

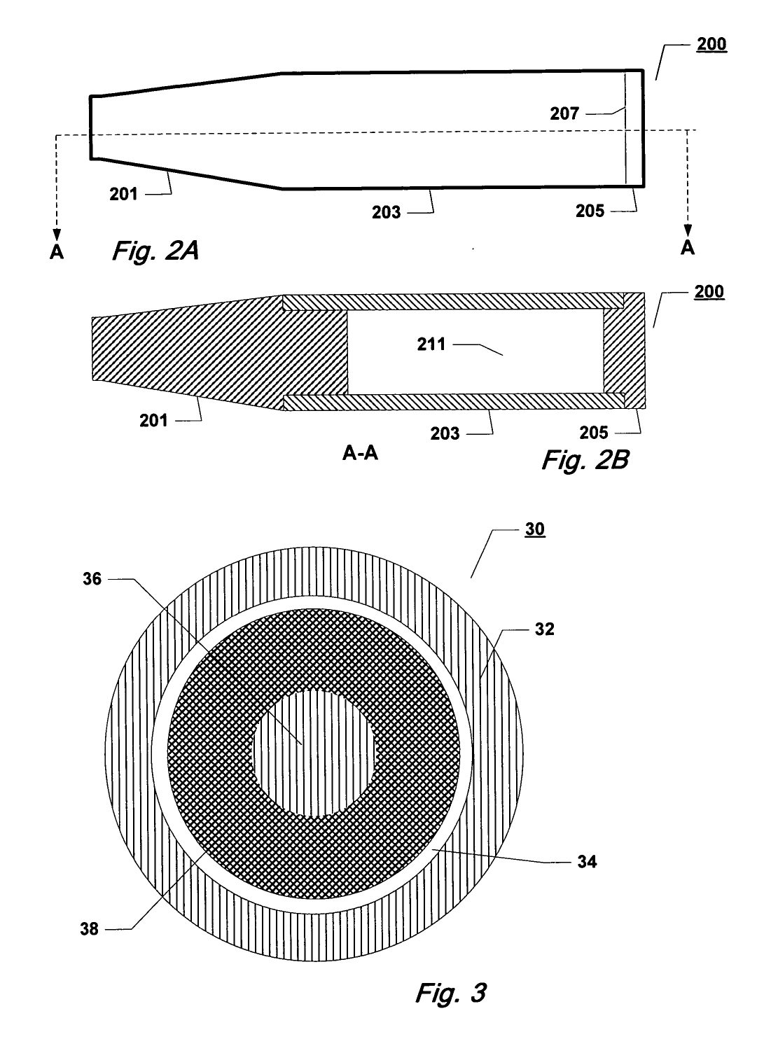

The various embodiments of the present invention and their advantages are best understood by referring to FIGS. 1 through 3 of the drawings. The elements of the drawings are not necessarily to scale, emphasis instead being placed upon clearly illustrating the principles of the invention. Throughout the drawings, like numerals are used for like and corresponding parts of the various drawings.

The drawings represent and illustrate examples of the various embodiments of the invention, and not a limitation thereof. It will be apparent to those skilled in the art that various modifications and variations can be made in the present inventions without departing from the scope and spirit of the invention as described herein. For instance, features illustrated or described as part of one embodiment can be included in another embodiment to yield a still further embodiment. Moreover, variations in selection of materials and/or characteristics may be practiced to satisfy particular desired user criteria. For example, the processes described below refer to the manufacture of Nb₃Sn superconducting wire, however, those skilled in the art with the benefit of this disclosure will recognize that the principles disclosed herein may be applied to the manufacture of a variety of composite, or multi-filamentary materials. Thus, it is intended that the present invention covers such modifications as come within the scope of the features and their equivalents.

Furthermore, reference in the specification to “an embodiment,” “one embodiment,” “various embodiments,” or any variant thereof means that a particular feature or aspect of the invention described in conjunction with the particular embodiment is included in at least one embodiment of the present invention. Thus, the appearance of the phrases “in one embodiment,” “in another embodiment,” or variations thereof in various places throughout the specification are not necessarily all referring to its respective embodiment.

This invention may be provided in other specific forms and embodiments without departing from the essential characteristics as described herein. The embodiments described above are to be considered in all aspects as illustrative only and not restrictive in any manner. The appended claims rather than the foregoing description indicate the scope of the invention.

A process for manufacturing composite superconducting wire is described first with reference to FIG. 1, where according to one embodiment of the present invention, a laminate is obtained 101 that comprised of a lamina of an expanded sheet of a first metal which is an alloy base and a lamina of a sheet of a reactant metal is obtained 103. The two laminae are pressed together using, for example, a flat press, or preferably, a rolling mill, forming the laminate. The laminate is formed into a roll around a core, preferably of copper (Cu), the roll being referred to hereafter as a “jelly roll.” The jelly roll is then inserted into a hollow recess of an extrusion vessel to form a billet 109. The billet is then reduced by extrusion through a hydrostatic press 111. The final step is iterative in order to achieve the desired diameter of superconducting wire. The base metal may be any metal that is a base element used in superconducting materials, now known or hereafter developed, for example, niobium, vanadium, or tantalum. Reactant metal may be any metal that is added to the base metal that is used to create the superconducting material, now known or hereafter developed, for example, tin, germanium, aluminum, titanium, or gallium. It will be understood that in some cases the base metals and the reactant metals may need to be pre-conditioned in order to be used in the method described herein. For example, metals should be annealed, and a de-greaser should be applied to the metal sheets prior to processing.

First lamina may be an expanded sheet, meaning a plurality of cuts is made into a solid sheet of base metal to form a pattern of apertures. A non-limiting example of such a pattern is the known 15NB27-2/0. When the reactant metal lamina is pressed together with the base metal lamina, the holes provide a void into which the reactant is interposed. Thicknesses of base metal sheet and reactant metal sheet may be of any suitable thickness to render the desired alloy upon being combined. For example, in rendering Nb₃Sn, an expanded sheet of Nb may be between about 0.005 inches and about 0.020 inches thick, depending upon the amount of Nb required to result in the forming of Nb₃Sn when the tin is applied thereto and the combination is reacted.

Preferably, at least in manufacturing Nb₃Sn, the base metal sheet is not flattened prior to creating the first lamina as the raised portions of the base metal sheet may cut into the soft Sn sheet allowing for a readier intermingling of Nb and Sn when the two are rolled together. The same principle may also apply when reactant metal is comparatively more ductile than the base metal, and vice-versa.

The apertures in the expanded base metal sheet should comprise between about 35% to about 50% of the area of the sheet. It will be appreciated by those skilled in the relevant arts with the benefit of reading this disclosure that the dimensions and open area of the base metal sheet may be adjusted as required to obtain the desired results. In other embodiments, first lamina may be a punch sheet or a sheet of wire mesh. First lamina preferably defines within its surface a plurality of voids into which the material of the second lamina enters when the two are pressed together to form the laminate.

Reactant metal sheet may be a solid sheet or an expanded sheet. If an expanded sheet is used, expanded reactant metal sheet, like the expanded base metal sheet, is formed by making a plurality of cuts into a solid sheet of the reactant metal, forming a pattern of apertures. The thickness of the reactant metal sheet will depend upon the desired composition of the material to be rendered. However, by way of non-limiting example in making Nb₃Sn, a sheet of Sn may be about 0.005 inches thick, again, depending upon the amount of Sn required to result in the forming of Nb₃Sn when applied to a base metal sheet of Nb and the combination is reacted. The apertures in the expanded reactant metal sheet should comprise about 35% of the area of the sheet. It will be appreciated by those skilled in the relevant arts with the benefit of reading this disclosure that the dimensions and open area of the Sn sheet may be adjusted as required to obtain the desired results.

Further, it will be appreciated that reactant metal sheet may comprise alloys of the reactant metal that may be used in lieu of 100% of the reactant metal. For example, benefits of increased filament tensile strength may be obtained by using a tin with about 5% silver. In addition, a foil of Babbitt metal may be used with proportions of about 89% tin, about 7.5% antimony and about 3.5% copper.

Preferably, the first laminate is rolled together with a third lamina to further stabilize the reactant metal material. For example in the manufacture of Nb₃Sn, a stabilizing lamina consisting of a sheet of copper may be rolled against the Sn layer, to form a three-component laminate. The copper sheet may be between about 0.005″ and about 0.010″ in thickness. The copper sheet provides longitudinal and lateral stability with respect to the laminate surface to prevent the Sn layer from moving during the formation of the jelly roll. Copper sheet may also be an expanded sheet with apertures comprising about 35% to about 50% of the area of the sheet. The copper used should preferably be as pure as possible, and may be copper 101 OFE. Material used in the stabilizing lamina is not limited, however, to copper. Any material that exhibits high electrical and thermal conductivity may be used. Some non-limiting examples include aluminum, silver and gold, as would be appreciated by those skilled in the relevant arts.

It should be noted that the dimensions of the reactant metal sheet need not match those of the base metal sheet. Moreover, the reactant metal sheet may be a plurality of smaller reactant metal sheets applied to the base metal sheet in non-abutting portions so that there is partial coverage of the base metal sheet by the reactant metal sheet. In this way, some bonding of the stabilizing sheet and the base metal sheet may occur, if desired, when the lamina is pressed with a stabilizing layer. The same is also true where the reactant metal sheet is an expanded sheet. The bonding of stabilizing metal to base metal in the three-component laminate stabilizes the reactant metal component during the rolling and extrusion steps. It should be noted that the term “stabilizer” at this point in the process refers the function of the stabilizer lamina in preventing physical movement of the reactant metal. However, this does not limit the function of stabilizing material. As is known in the superconducting arts, a stabilizer material is often necessary to mitigate the effects of flux jumping when the material is in a superconductive state. Therefore, it will be understood that stabilizer lamina may be comprised of material that not only prevents components shifting, but also functions as a conducting stabilizer as well.

Alternatively, stabilizing sheet may be first pressed together with the reactant metal sheet and then this laminate may be pressed together with the base metal sheet, with the reactant metal sheet in the middle. In addition, all components are preferably annealed prior to processing. It should be noted that laminate need not comprise two or three laminae, but four as well. For example, an additional lamina could be a sheet, or expanded sheet of Aluminum. In any event, all components should be cleaned with an alcohol de-greaser before processing.

The step of forming into a roll comprises rolling the laminate around a core. Material chosen of the core preferably exhibits good malleability. In some applications, it is desirable for the core material of possess high electrical and high thermal conductivity. For example, when making Nb₃Sn, the core could be a copper or aluminum rod. In other applications, it may be desirable for the core material to possess high mechanical strength. In such cases, it would be preferable to use tantalum, nickel or vanadium. A consideration in choosing core material is that the core material's coefficient of thermal expansion should roughly be the same as that of the superconducting material. This is so that in the heat treatment process, the component materials do not expand at differing rates.

In this step, it is preferable to reduce the dead volume in the jelly roll as much as possible. An apparatus suited to this is a conventional three-roll former adapted to have uniform pressure applied to the jelly roll formation. A further adaptation includes the use of a means for maintaining the tightness of the roll as it is winding. One way to achieve such means is by anchoring one side of a sheet of metal, preferably stainless steel or copper alloy, to the apparatus, allowing the remainder of the sheet to rest upon one of the rollers.

The laminate may be wound about the core as a single sheet. If desired, the laminate may also be applied in a crosswise manner with respect to the direction of extrusion. In using this technique, the laminate may be cut into six inch strips. This is of particular use when making larger jelly rolls.

As would be appreciated by those skilled in the relevant arts, the size of the jelly roll depends upon desired output of superconducting wire in terms of wire length and diameter. For example, one application for such wire may require a wire length of 10,000 meters and an effective conducting diameter of about 0.040 inches would require a jelly roll of about four feet long and 2.9 inches in diameter. Therefore, dimensions of the base metal, reactant metal and stabilizing metal sheets must be about four feet in width and long enough to form a jelly roll of the required diameter assuming the thicknesses of the three component layers. Additionally, the jelly roll former should be adapted to accommodate and form the jelly roll of the appropriate size.

To initiate rolling the laminate onto the core, core may comprise a longitudinal slot in the surface of the core into which a leading edge of the laminate may be inserted. The core is then turned as the laminate is fed into it. In the alternative, core may be wound within a sheet of core material, and then the component sheets are inserted into trailing flap of this sheet, pinning the starting end of the lamina sheet against the core.

It is preferable to wrap the entire roll in a foil of a metal to resist the diffusion of the constituent components of the jelly roll into the extrusion vessel material. For example, some of the tin an unwrapped jelly roll formed of Nb and Sn sheets would react with material of the extrusion. Advantageously, this keeps as much of the reactant metal as possible available for reaction with the base metal, ultimately increasing the content of superconductor material, over the methods of the prior art. This directly contributes to an increase in current density. Suitable elements that may be used in this outer barrier include Tantalum, for example, or other non-superconducting metals.

In addition, it is also preferable that for larger core diameters, i.e., about 0.75 inches or greater, the core is wrapped in a foil of barrier material as well to prevent loss of reactant metal to bonding with the core material. Optionally, if the barrier material is a rolled foil, the barrier material may be wrapped such that the direction of roll is either parallel or perpendicular to the longitudinal axis, and thus, the direction of extrusion, of the jelly roll. The foil used as a barrier material need only be about 0.0015 inches in thickness. Preferably, however, the foil should be about 0.006 inches in thickness. A final option may include another foil wound with the laminate to form separation layers between the rolls. This could be copper or other suitable material and need be only about 0.005 inches in thickness.

A billet is produced by obtaining an extrusion vessel formed from copper. FIGS. 3A and B depict an exemplary extrusion vessel 200 having a nose portion 201, a can portion 203 and a cap 205. A cylindrical extrusion vessel 200 may be formed of pure 101 Cu. Alternatively, nose 201 may be Aluminum, or other suitable metal. Dimensions of extrusion vessel will depend upon the desired wire length and diameter. Cap 205 is affixed typically by welding, to the aft portion of can 203. The jelly roll is inserted into the hollow 211 of can portion and nose 201 may be affixed to can in any suitable sealing method, including, without limitation, shrink fitting. Weld 207 may be an e-beam weld or other suitable technique.

Preferably, the nose portion of the extrusion vessel should include a centerline hole roughly ⅜ to ¼ inch in diameter. This allows the coupling of a vacuum pump to the vessel to extract any extraneous gases from within the cylinder. The vacuum should be capable of providing 10⁻⁵ Torr, and removed when a suitably low pressure level is reached within the vessel.

This evacuation takes places once the extrusion vessel is place within the pressure vessel. The nose is inserted through the die with the pump-out tube extending from the hole provided. Once the evacuation is complete, the nose is crimped to maintain the vacuum within the cylinder.

Hydrostatic extrusion is used because it is able to provide sufficient pressure to achieve a greater reduction ratio, and yet at reduced temperatures compared to direct extrusion because there is no heat added to the process. The only heating that occurs is adiabatic. It is well-known that tin has a low melting point, and other metals, and the resulting extruded structure may fail as a result of melting brought about by adiabatic heating during extrusion. But because of the fluid used in the pressure chamber, the likelihood of increased temperatures is reduced, meaning less stress on the material. This means that the area reduction ratio may be increased over previous methods. The reduction ratio is chosen to be the maximum without resulting to excessive adiabatic heating which will melt the tin. It has been shown that the higher the reduction ratio, the greater the stress on the extruded product, but the less the likelihood of failure of the internal structure of the components. Therefore, it is desired to extrude using a higher reduction ratio. However, the greater the reduction ratio, greater adiabatic heating occurs. Thus, the reduction ratio is chosen to be the maximum possible, without resulting in excessive adiabatic heating. For this embodiment, the reduction ratio, in terms of cross-sectional area of the billet, is preferably 4:1.

In hydrostatic extrusion the billet is placed inside a pressure chamber that is filled with a fluid. The fluid is compressed by a ram or piston, and as the fluid pressure increases, the billet is extruded through a die, reducing the diameter of the billet, producing a rod with a ring structure comprised of the base metal, reactant metal, and if used, the stabilizing metal, all encased in copper. For the application described herein, the hydrostatic extrusion preferably operates to about 150,000 psi. The fluid chosen should have the least amount of viscosity when it is subjected to such extreme pressures. It was found that a suitable fluid was a Castor oil solution, preferably diluted with about 20% by volume of ethyl alcohol.

In reducing the invention to practice two hydrostatic press facilities were used. An 850-ton hydrostatic press located at Concurrent Technologies Corporation in Pennsylvania, and at the University of Wisconsin-Madison. Pressure required to provide desired area reduction ratios are about 150,000 psi. Hydrostatic presses may be augmented with hydraulic intensifier packs to achieve the required pressure. It will be apparent to those skilled in the art that the pressure chamber used needs to be designed to accommodate the desired extrusion vessel.

Additionally, it will be further appreciated that the extrusion step is iterative in order to achieve the desired wire diameter. Still further, extrusion may comprise both linear extrusion, i.e., extrusion of the billet or a straight rod, and “coiled” extrusion where the rod or wire may be coiled within the pressure chamber. Coiling of the material to be extruded within the pressure may be solenoidal, or the like. It will be appreciated that for longer desired wire dimensions, the pressure chamber should be constructed with greater inside diameters. For example, if a wire of 10,000 m and 0.040 inches in diameter is desired, a pressure vessel of at least about six inches inside diameter to about twelve inches or more is desired. If linear extrusion is used, rods may be cut at intervals to fit within the pressure chamber. It may also be necessary to employ more than one pressure chamber in the extrusion process: one or more for linear extrusion, and one or more for coiled extrusion. Transfer from linear extrusion process to coiled extrusion occurs at a point, in terms of wire diameter, when the material can be coiled without damage. Because of the pressures exerted during hydrostatic extrusion, it will be preferable to construct the extrusion vessel so that the interior thereof is sealed to prevent introduction of fluid into the can during extrusion.

It will be appreciated that the above described process may be used for, not only the metals and alloys described, but for many other suitable metals or alloys used to create superconductors. Other examples include without limitation, Vanadium, Gallium, Germanium, Aluminum, or Titanium. The metals or alloys used should be suitably ductile to allow working in the manner described above. Non-limiting examples of other materials that may be manufacturing by this process include NbTi, V₃Ga, Nb₃Al, Nb₃Ge, and Nb₃(Al, Ge).

Several example billets have been formed that demonstrate the effectiveness of the method disclosed above in the making of Nb₃Sn. One billet in particular was reduced by a factor of 1200 to 1 over 5 iterations. A precursor Nb₃Sn wire produced in the manner described above will have no lost tin. Further, since the tin is trapped, longitudinally with respect to the direction of extrusion by the expanded niobium and radially by the copper foil, there is a uniform concentration of tin throughout the wire cross section. Also, final heat treatment time is reduced because a more pure form of tin is juxtaposed with the niobium and does not need to diffuse from bronze into the niobium structure as it does in the bronze processes described in U.S. Pat. Nos. 4,262,412 and 4,414,428.

The resulting wire cross section 30, after heat treatment, is described with reference to FIG. 3. Outer layer 32 is the reduced extrusion vessel shell and encases superconducting constituent components which comprise the barrier layer 34, the core 36 and the superconducting area 38. Superconducting area 38 is a circumvoluted structure composed of alternating layers of base metal reacted with reactant metal which form superconducting filaments disposed in a matrix of stabilizer, or a stabilizer alloy. For example, if the superconducting material were Nb₃Sn, and the stabilizing material were copper, a bronze matrix would result from reaction of the tin with the copper stabilizer. The Nb₃Sn is disposed in layers of fine filaments, i.e., having an effective filament diameter of less than 50 microns, and typically less than 20 microns, including filaments of less than 10 microns.

Advantageously, prior to reaction, the tin is uniformly distributed, thus the Nb₃Sn is uniformly distributed throughout area, and preferred uniform Nb₃Sn content results. As discussed above, this is because of the higher tin content through use of a solid tin or tin alloy sheet, a stabilizer lamina of copper which prevented movement of the tin during reduction, and the use of a barrier sheet 34 which restricts the diffusion of tin to the outer layer 32. Another advantage of the above described process is that the phenomenon of “flux jumping” is reduced further contributing to increased useful current density.

Wires produced by this method provide superior superconducting characteristics over previously known commercially produced superconducting wires. As noted above, wires formed in the “internal tin” process may achieve a current density of about 3000 A/mm², however, the effective filament size cannot be reduced below 50 microns. Superconducting wires produced by the present method achieve can current density of about 3,250 A/mm² up to about 3,900 A/mm², but with a effective filament diameter of about 20 microns or less. The above described process can achieve, however, an effective filament diameter of less than about 10 microns while maintaining the useful current density as would be appreciated by one skilled in the relevant arts with the benefit of this disclosure.

As described above and shown in the associated drawings, the present invention comprises a method of producing superconducting wire and articles produced thereby. While particular embodiments of the invention have been described, it will be understood, however, that the invention is not limited thereto, since modifications may be made by those skilled in the art, particularly in light of the foregoing teachings. It is, therefore, contemplated by the following claims to cover any such modifications that incorporate those features or those improvements that embody the spirit and scope of the present invention.

We claim:

1. A method of manufacturing multi-filamentary superconducting wire comprising the steps of:
a. obtaining a laminate of an expanded base metal lamina and a reactant metal lamina;
b. forming a circumvolute roll having substantially no dead volume by tightly wrapping said laminate around a metal core and wrapping a barrier metal around said wrapped laminate;
c. forming a billet by placing said roll into a hollow of a vessel, said hollow being depressurized to maintain a vacuum therein; and
d. reducing the cross-sectional area of said billet by forcing said vessel through a die using hydrostatic pressure.

2. The method of claim 1, wherein said step of reducing comprises reducing said area by a ratio of no more than about 4:1.

3. The method of claim 1, wherein
a. said base metal is one of niobium, and vanadium; and
b. said reactant metal is at least one of tin, titanium, germanium, gallium and aluminum.

4. The method of claim 1, wherein said barrier is metal is tantalum.

5. The method of claim 1, wherein said core is copper.

6. The method of claim 1, wherein said laminate further comprises a stabilizer lamina for preventing radial movement of reactant metal during processing, said stabilizer lamina being one of an expanded metal and a solid metal.

7. The method of claim 6, wherein said stabilizer lamina is copper.

8. The method of claim 7, wherein said expanded base metal lamina is niobium, said reactant metal lamina is tin, and said barrier metal is tantalum.

9. The method of claim 8, wherein said reactant metal is a tin alloy.

10. A superconducting wire manufactured using the process set forth in claim 1.

11. The superconducting wire of claim 10, wherein said step of reducing comprises reducing said area by a ratio of no more than about 4:1.

12. The superconducting wire of claim 11, wherein
a. said base metal is one of niobium, vanadium; and
b. said reactant metal is at least one of tin, titanium, germanium, gallium and aluminum.

13. The superconducting wire of claim 12, wherein said laminate further comprises a stabilizer lamina for preventing radial movement of reactant metal during processing, said stabilizer lamina being one of an expanded metal and a solid metal.

14. The superconducting wire of claim 13, wherein said barrier metal is tantalum.

15. The superconducting wire of claim 13, wherein said expanded base metal lamina is niobium, said reactant metal lamina is tin, and said barrier metal is tantalum.

16. The method of claim 15, wherein said reactant metal is a tin alloy.

17. A superconducting wire comprising:
a. a hydrostatically reduced circumvoluted laminate of an expanded sheet of base metal and a sheet of reactant metal co-axially disposed about a core metal.

18. The superconducting wire of claim 17, wherein said base metal is one of niobium and vanadium, and said reactant metal is one of tin, titanium, germanium, gallium and aluminum.

19. The superconducting wire of claim 18, wherein said laminate is a laminate of an expanded sheet of base metal, a sheet of reactant metal, and a stabilizer lamina for preventing radial movement of said reactant metal during processing.

20. The superconducting wire of claim 19, wherein said stabilizer lamina is copper.

21. The superconducting wire of claim 19, wherein said stabilizer lamina is an expanded sheet.

22. The superconducting wire of claim 19, wherein said reactant metal is uniformly distributed about said base metal.

23. The superconducting wire of claim 17, further comprising a barrier metal disposed around said coaxially disposed laminate.

24. The superconducting wire of claim 23, wherein said base metal is one of niobium and vanadium, and said reactant metal is one of tin, titanium, germanium, gallium and aluminum.

25. The superconducting wire of claim 23, wherein said laminate is a laminate of a base metal, a reactant metal, and a stabilizer non-reactant metal lamina for preventing radial movement of said reactant metal during processing.

26. The superconducting wire of claim 25, wherein said expanded base metal lamina is niobium, said reactant metal lamina is one of tin and a tin alloy, and said barrier metal is tantalum.

27. The superconducting wire of claim 17, wherein said superconducting material is Nb₃Sn having a current density greater than about 3000 A/mm² and an effective filament diameter that is at most about 20 microns.

28. The superconducting wire of claim 27, wherein said superconducting material has an effective filament diameter of at most about 10 microns.
